(19) United States
(12) Patent Application Publication
(10) Pub. No.: US 2012/0198865 A1
(43) Pub. Date: Aug. 9, 2012

(54) VEHICLE AIR CONDITIONING CONTROL

(75) Inventor: Thomas K. LOCKWOOD, Mackinac Island, MI (US)

(73) Assignee: GM GLOBAL TECHNOLOGY OPERATIONS LLC, DETROIT, MI (US)

(21) Appl. No.: 13/022,441

(22) Filed: Feb. 7, 2011

(51) Int. Cl. F25D 17/06; B60H 1/32

(52) U.S. Cl. 62/89; 62/186; 62/133

(57) ABSTRACT

Methods and systems are provided for controlling an air conditioning system of a vehicle, the air conditioning system having a condenser fan, are provided. An ambient temperature is obtained. A power setting for the condenser fan is controlled such that energy usage of the air conditioning system is minimized, using the ambient temperature and other available inputs.

### TECHNICAL FIELD

The present disclosure generally relates to the field of vehicles and, more specifically, to methods and systems for controlling air conditioning systems of vehicles.

### BACKGROUND

Automobiles and various other vehicles often utilize air conditioning systems for cooling an interior of the vehicle. Such air conditioning systems typically include a mechanical compressor to compress the refrigerant, changing its condition from a low pressure cool gas (as it exits the evaporator) to a high pressure hot gas (as it enters the condenser). For most car and light-duty truck applications an electric fan is used to circulate the cooling air over the condenser. The fan is typically operated at one of a few predetermined power levels (for example, low, and high) depending on a vehicle speed and refrigerant pressure. However, such air conditioning systems may not optimize energy usage of the air conditioning system.

Accordingly, it is desirable to provide improved methods for controlling air conditioning systems for vehicles, for example that provide reduced energy usage for the air conditioning system. It is also desirable to provide improved systems for such control of air conditioning systems. Furthermore, other desirable features and characteristics of the present invention will be apparent from the subsequent detailed description and the appended claims, taken in conjunction with the accompanying drawings and the foregoing technical field and background.

### SUMMARY

In accordance with an exemplary embodiment, a method for controlling an air conditioning system of a vehicle, the air conditioning system having a condenser fan, is provided. The method comprises the steps of obtaining an ambient temperature, and controlling a setting for the condenser fan that controls energy usage of the air conditioning system based at least in part on the ambient temperature.

In accordance with another exemplary embodiment, a method for generating a calibration for use in controlling an air conditioning system of a vehicle, the air conditioning system having a condenser fan, is provided. The method comprises the steps of setting an ambient temperature value to an ambient temperature and operating the condenser fan at a plurality of power levels at the ambient temperature value, determining an amount of energy used by the air conditioning system at each of the plurality of power levels, generating energy determinations, and determining, using a processor and the energy determinations, a selected power level of the plurality of power levels for the ambient temperature value, for the calibration.

In accordance with a further exemplary embodiment, a system for controlling an air conditioning system of a vehicle, the air conditioning system having a condenser fan, is provided. The system comprises a sensor and a controller. The sensor is configured to measure an ambient temperature. The controller is coupled to the sensor, and is configured to control a setting for the condenser fan that controls energy usage of the air conditioning system based at least in part on the ambient temperature.

### BRIEF DESCRIPTION OF THE DRAWINGS

The present disclosure will hereinafter be described in conjunction with the following drawing figures, wherein like numerals denote like elements, and wherein:

FIG. 1 is a functional block diagram of a system of an air conditioning control system for a vehicle, such as an automobile, in accordance with an exemplary embodiment;

FIG. 2 is a flowchart of a process for controlling an air conditioning system of a vehicle, and that can be used in connection with the system of FIG. 1, in accordance with an exemplary embodiment; and

FIG. 3 is a flowchart of a sub-process of the process of FIG. 2, including a sub-process for developing an air conditioning control calibration for a vehicle, and that can also be used in connection with the system of FIG. 1, in accordance with an exemplary embodiment.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

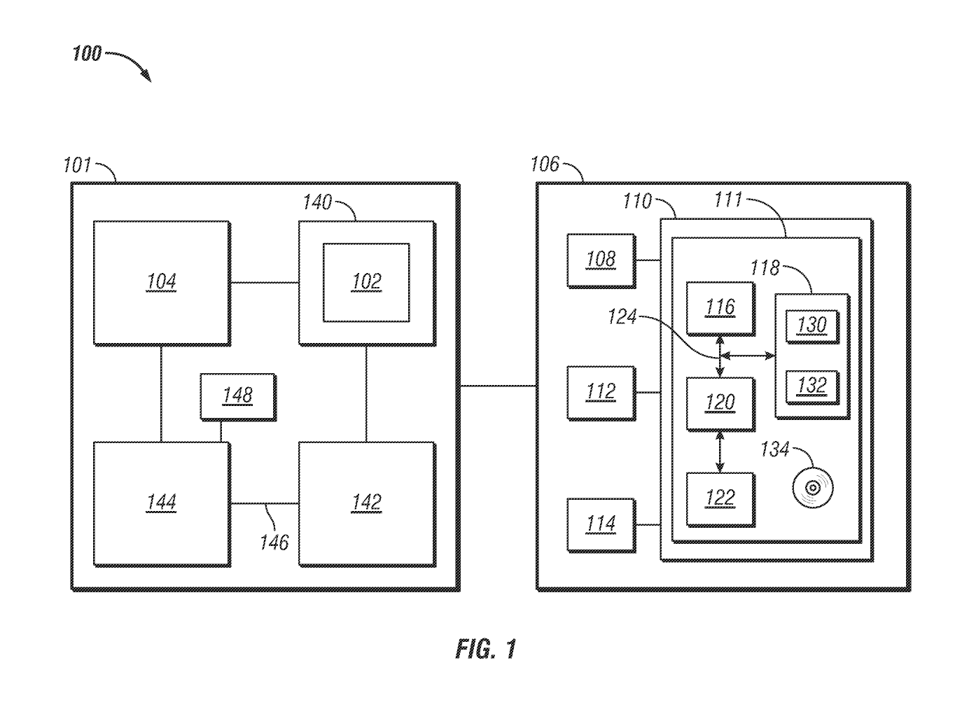

FIG. 1 is a block diagram of an exemplary system 100 for use in a vehicle. In a preferred embodiment, the vehicle comprises an automobile, such as a sedan, a sport utility vehicle, a van, or a truck. However, the type of vehicle may vary in different embodiments.

The system 100 includes an air conditioning system 101 for a vehicle and/or components thereof (preferably including a condenser fan 102 and a compressor 104), along with a control unit 106. As depicted in FIG. 1, the air conditioning system includes the above-referenced compressor 104, a condenser 140 with the above-referenced condenser fan 102, a receiver/dehydrant 142, an evaporator 144, a thermal expansion valve 146, and a thermostat 148. Low pressure gas (refrigerant) flows from the evaporator 144 to the compressor 104, preferably via an evaporator fan (not depicted in FIG. 1). The low pressure gas is compressed in the compressor 104, and high pressure gas (refrigerant) flows from the compressor 104 to the condenser 140. The condenser 140 condenses the high pressure gas, and the resulting high pressure liquid (refrigerant) flows from the condenser 140 to the receiver/dehydrator 142 via the condenser fan 102. Liquid/gas then flows from the receiver/dehydrator 142 to the evaporator 144 via the thermal expansion valve 146. A thermostat 148 is also coupled to the evaporator 144, and measures a temperature of the air conditioning system 101 proximate the evaporator 144.

In certain embodiments, the air conditioning system 101 comprises the condenser fan 102 and the compressor 104, and the control unit 106 is separate from and coupled to the air conditioning system 101. In other embodiments, the condenser fan 102, the compressor 104, and the control unit 106 (and/or one or more components thereof) are all part of the air conditioning system of the vehicle.

The compressor 104 compresses the refrigerant, changing it from a low temperature, low pressure gas as it leaves the evaporator to a high temperature, high pressure gas as it enters the condenser thereby initiating the refrigerant cycle. The condenser fan 102 is coupled to the controller 106. The condenser fan 102 circulates ambient air over the condenser, changing the state of the refrigerant within the condenser from a high pressure, hot gas to a high pressure liquid. In one embodiment, the condenser fan 102 comprises a highly efficient, brushless, variable power fan. The condenser fan 102 preferably can be operated at a larger number of different power levels, as compared with traditional fans that typically operate at a limited number of power levels (for example, low and high). The various power levels for the condenser fan 102 are preferably continuous in nature.

The control unit 106 is coupled to the condenser fan 102. The control unit 106 controls a power level of the condenser fan 102 in a manner that reduces energy usage of the air conditioning system. In one embodiment, energy is reduced to minimize energy usage by the condenser fan. In another embodiment, energy use is minimized for the entire air conditioning system. Preferably, the control unit 106 controls the power level of the condenser fan 102 based on the ambient temperature, a requested air conditioning load, and a calibration relating the ambient temperature, the requested air conditioning load, and the condenser fan power level. As referenced throughout this application, the requested air conditioning load preferably pertains to a preferred air conditioning temperature and evaporator blower setting desired by a user of the vehicle.

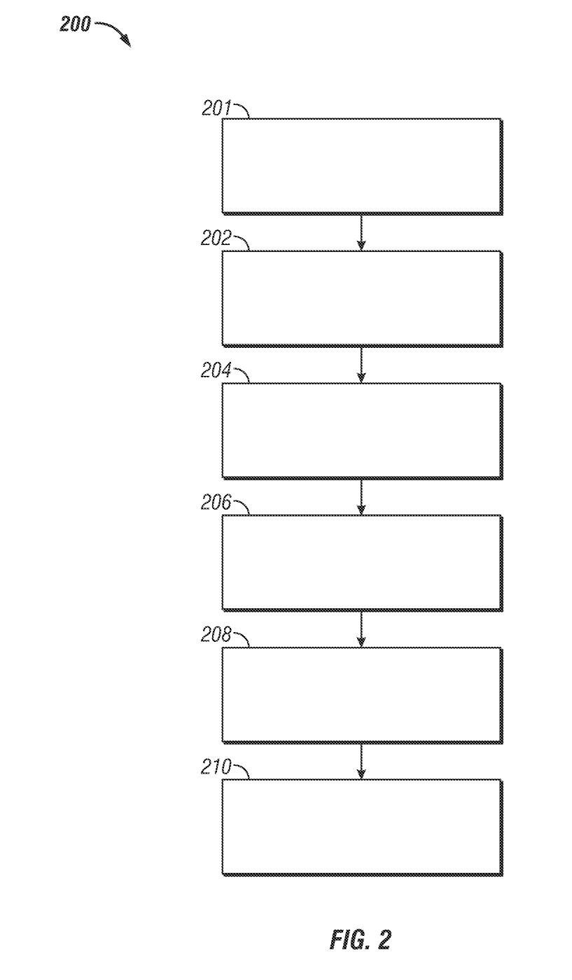

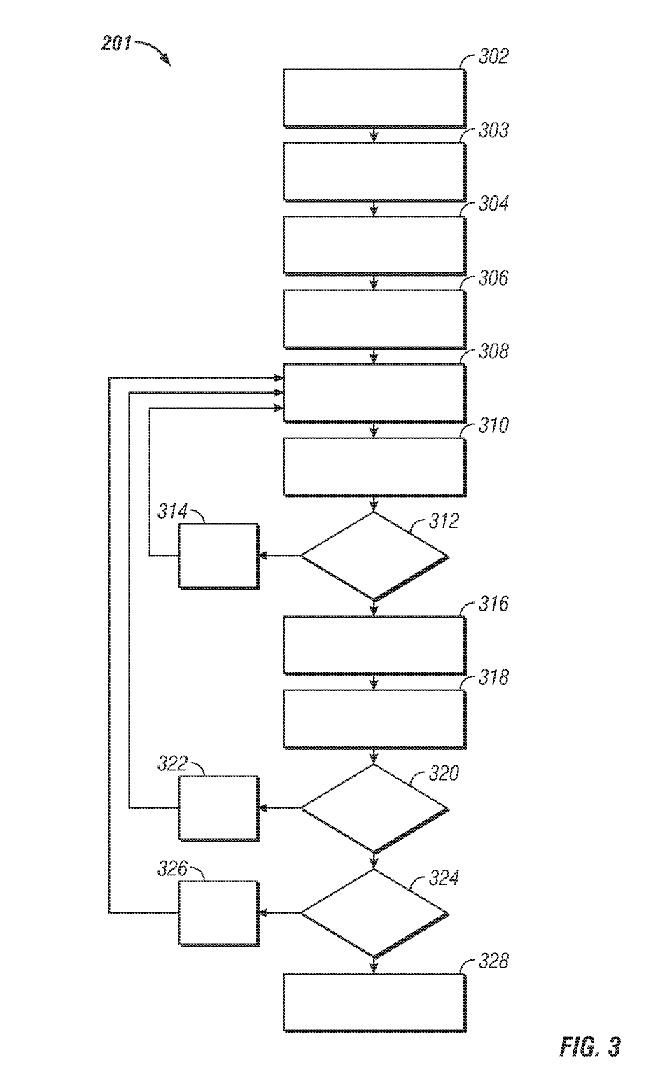

The control unit 106 preferably controls the condenser fan 102 in such a manner that controls a combined energy usage or consumption of the condenser fan 102 and the compressor 104, to thereby control energy usage of the air conditioning system and maximize fuel economy for the vehicle. Preferably, the control unit 106 reduces the energy usage of the air conditioning system by reducing the total combined energy usage of the condenser fan 102 and the compressor 104, to thereby improve fuel economy for the vehicle.. Most preferably, the control unit 106 minimizes the energy usage of the air conditioning system by minimizing the total combined energy usage of the condenser fan 102 and the compressor 104, to thereby maximize fuel economy for the vehicle. The control unit 106 preferably performs these functions in accordance with the steps of the process 200 set forth in FIGS. 2 and 3 and described further below in connection therewith. In certain embodiments, the control unit 106 also controls operation of the compressor 104 and/or other components of the air conditioning system.

As depicted in FIG. 1, the control unit 106 comprises one or more sensors 108 and a controller 110. The one or more sensors 108 preferably include an ambient temperature sensor that is disposed on an exterior portion of the vehicle. In one preferred embodiment, the one or more sensors 108 are disposed behind a grille of the vehicle (not depicted in FIG. 1), and measure an outside air temperature (OAT) proximate the vehicle. Other sensors 108, such as a fuel usage sensor for the vehicle, one or more other sensors serving as an indicator for energy usage for the air conditioning system, and/or one or more sensors configured to detect an input from a user as to a requested air conditioning load for the air conditioning system, may also be utilized in certain embodiments. The measurements from the sensors 108 and/or information pertaining thereto are provided by the sensors 108 to the controller 110 for processing and for controlling the air conditioning system of the vehicle. The number and/or types of sensors 108 may vary in different embodiments.

In certain embodiments, the control unit 106 may further comprise one or more receivers 112 and/or one or more other vehicle modules 114. The one or more receivers 112 are coupled to the controller 110. The receivers 112 receive information for use in controlling the condenser fan 102. Specifically, in one embodiment, the receivers 112 receive data pertaining to an ambient temperature outside the vehicle. In another embodiment, the receivers 112 receive data pertaining to an input from a user as to a requested air conditioning load for the air conditioning system. The data from the receivers 112 and/or information pertaining thereto are provided by the receivers 112 to the controller 110 for processing and for controlling the air conditioning system of the vehicle. The number and/or types of receivers 112 may vary in different embodiments.

Also in certain embodiments, the control unit 106 may further comprise one or more other modules 114. The one or more other modules 114 are coupled to the controller 110, and provide information to the controller 110 for use in controlling the condenser fan 102. Specifically, in one embodiment, one such other module 114 comprises an input unit from a dashboard of the vehicle that provides information to the controller 110 as to an input received from a user pertaining to a requested air conditioning load and/or setting for the air conditioning system. In another embodiment, one such other module 114 comprises an existing vehicle sensing module that obtains or measures an ambient temperature of the vehicle. The data from the other modules 114 and/or information pertaining thereto are provided by the other modules 114 to the controller 110 for processing and for controlling the air conditioning system of the vehicle. The number and/or types of other modules 114 may vary in different embodiments.

The controller 110 is coupled to the sensors 108, and to the condenser fan 102 and the compressor 104. In certain embodiments, the controller 110 is also coupled to one or more receivers 112 and/or one or more other vehicle modules 114. The controller 110 processes the data and information from the sensors 108 (and, in some embodiments, from the receiver 112 and/or other modules 114) for use in controlling the condenser fan 102 in a manner that minimizes energy usage of the air conditioning system and thereby preferably maximizes fuel economy for the vehicle. The controller 110 preferably performs these functions in accordance with the steps of the process 200 depicted in FIGS. 2 and 3 and described further below in connection therewith.

In the depicted embodiment, the controller 110 comprises a computer system 111. In certain embodiments, the controller 110 may also include one or more of the sensors 108, the receivers 112, and/or the other vehicle modules 114, among other possible variations. In addition, it will be appreciated that the controller 110 may otherwise differ from the embodiment depicted in FIG. 1, for example in that the controller 110 may be coupled to or may otherwise utilize one or more remote computer systems and/or other control systems.

In the depicted embodiment, the computer system 111 is coupled to the sensors 108, the receivers 112, and the other vehicle modules 114. The computer system 111 performs the functions of the controller 110, for example in receiving signals or information from the various sensors 108, the receivers 112, and the other vehicle modules 114 pertaining to the ambient temperature and the requested air conditioning load, processing these signals or information, and controlling the air conditioning system of the vehicle. In a preferred embodiment, these and other functions are conducted in accordance with the process 200 depicted in FIGS. 2 and 3 and described further below in connection therewith.

In the depicted embodiment, the computer system 111 includes a processor 116, a memory 118, an interface 120, a storage device 122, and a bus 124. The processor 116 performs the computation and control functions of the computer system 111 and the controller 110, and may comprise any type of processor or multiple processors, single integrated circuits such as a microprocessor, or any suitable number of integrated circuit devices and/or circuit boards working in cooperation to accomplish the functions of a processing unit. During operation, the processor 116 executes one or more programs 130 contained within the memory 118 and, as such, controls the general operation of the controller 110 and the computer system 111, preferably in executing the steps of the processes described herein, such as the process 200 depicted in FIGS. 2 and 3 and described further below in connection therewith.

The memory 118 can be any type of suitable memory. This would include the various types of dynamic random access memory (DRAM) such as SDRAM, the various types of static RAM (SRAM), and the various types of non-volatile memory (PROM, EPROM, and flash). The bus 124 serves to transmit programs, data, status and other information or signals between the various components of the computer system 111. In a preferred embodiment, the memory 118 stores the above-referenced program 130 along with one or more look-up tables 132. The one or more look-up tables 132 preferably comprise a calibration relating the ambient temperature, the requested air conditioning load, and a selected operating level for the condenser fan 102 in a manner that optimizes energy usage for the air conditioning system. The look-up tables 132 are preferably used in controlling the air conditioning system in accordance with steps of the process 200 depicted in FIGS. 2 and 3 and described further below in connection therewith. In certain examples, the memory 118 is located on and/or co-located on the same computer chip as the processor 116.

The interface 120 allows communication to the computer system 111, for example from a system driver and/or another computer system, and can be implemented using any suitable method and apparatus. It can include one or more network interfaces to communicate with other systems or components. The interface 120 may also include one or more network interfaces to communicate with technicians, and/or one or more storage interfaces to connect to storage apparatuses, such as the storage device 122.

The storage device 122 can be any suitable type of storage apparatus, including direct access storage devices such as hard disk drives, flash systems, floppy disk drives and optical disk drives. In one exemplary embodiment, the storage device 122 comprises a program product from which memory 118 can receive a program 130 that executes one or more embodiments of one or more processes of the present disclosure, such as the process 200 of FIG. 2 or portions thereof. In another exemplary embodiment, the program product may be directly stored in and/or otherwise accessed by the memory 118 and/or a disk (e.g. disk 134), such as that referenced below.

The bus 124 can be any suitable physical or logical means of connecting computer systems and components. This includes, but is not limited to, direct hard-wired connections, fiber optics, infrared and wireless bus technologies. During operation, the program 130 is stored in the memory 118 and executed by the processor 116.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 116) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will similarly be appreciated that the computer system 111 may also otherwise differ from the embodiment depicted in FIG. 1, for example in that the computer system 111 may be coupled to or may otherwise utilize one or more remote computer systems and/or other control systems.

FIG. 2 is a flowchart of a process 200 for controlling an air conditioning system of a vehicle, in accordance with an exemplary embodiment. The process 200 can preferably be utilized in connection with the system 100 of FIG. 1, the controller 110, and/or the computer system 111 of FIG. 1, in accordance with an exemplary embodiment.

As depicted in FIG. 2, the process 200 includes the step of developing a calibration for controlling a condenser fan for the air conditioning system (step 201). During step 201, a calibration is preferably generated that relates an ambient temperature, a requested air conditioning load, and a condenser fan power setting for the air conditioning system. In one embodiment, the calibration provides an optimal (or preferred) fan power setting (as a dependent variable) under various combined conditions of the ambient temperature and the requested air conditioning load (as independent variables). The fan preferably corresponds to the condenser fan 102 of FIG. 1. The calibration is preferably developed by the control unit 106 of FIG. 1.

Turning now to FIG. 3, a flowchart is provided illustrating an exemplary embodiment of a sub-process for step 201 of the process of FIG. 2, namely, developing the calibration. As depicted in FIG. 3, the sub-process 201 begins with setting up the vehicle in a controlled environment (step 302). During step 302, a vehicle is preferably placed within a wind tunnel In one embodiment, one or more selected vehicles of a particular model of vehicle are tested in the wind tunnel during the sub-process 201, so that appropriate values can be pre-loaded into the vehicles of this model type. Accordingly, the actual vehicle used for the sub-process 201 of FIG. 3 may differ (but is preferably of the same model and type as) the vehicle that is used in the remaining steps of the process 200 of FIG. 2.

The vehicle set-up is preferably performed or facilitated by the control unit 106 of FIG. 1 (preferably, by the processor 116 thereof), and/or by a user and/or another system coupled to the control unit 106. The vehicle is preferably disposed in a controlled wind tunnel throughout the sub-process 201.

An air conditioning load is set (step 303). Preferably, the air conditioning load is set by the control unit 106 of FIG. 1 (preferably, by the processor 116 thereof), based on a requested air temperature and/or other air conditioning setting from a driver or other user of the vehicle. In one exemplary embodiment, the air conditioning load is set to a value that is approximately equal to full evaporator blower (or interior fan) power setting, with temperature set to a maximum cold or maximum cooling setting for the air conditioning system.

An ambient temperature is also set (step 304). Preferably, the ambient temperature is set for the wind tunnel surrounding the vehicle. The ambient temperature is preferably set by the control unit 106 of FIG. 1 (preferably, by the processor 116 thereof), and/or by a user and/or another system coupled to the control unit 106. In one exemplary embodiment, the ambient temperature is initially set to one hundred twenty degrees Fahrenheit (120° F.).

In addition, a condenser fan power level is also set (step 306). Preferably, a power level is set with respect to the condenser fan 102 of FIG. 1. The fan power level is preferably set by the control unit 106 of FIG. 1 (preferably, by the processor 116 thereof), and/or by a user and/or another system coupled to the control unit 106. In one exemplary embodiment, the ambient temperature is initially set to ten percent (10%) of its full power capacity.

An engine of the vehicle is run (step 308). In certain embodiments, the engine may begin running prior to or simultaneously with steps 303-306, for example during the vehicle set-up of step 302. Regardless, the engine operation is preferably set to an idle condition in step 308, and preferably remains in an idle condition throughout the remainder of the sub-process 201. The engine is preferably started by the control unit 106 of FIG. 1 (preferably, by the processor 116 thereof), and/or by a user and/or another system coupled to the control unit 106.

An amount of energy usage is determined (step 310). The amount of energy usage preferably comprises a total combined energy usage of the condenser fan 102 of FIG. 1 and the compressor 104 of FIG. 1. In one embodiment, a relative energy usage for the air conditioning system is determined by measuring an amount of fuel consumed by the vehicle in the wind tunnel In one such embodiment, the relative fuel consumption is measured by one of the sensors 108 of FIG. 1, and information pertaining thereto is provided to the controller 110 of FIG. 1 for estimating the relative energy usage. The relative energy usage values are subsequently used for determining optimal (or preferred) fan settings under various conditions of ambient temperature and requested air conditioning loads, as set forth further below.

A determination is made as to whether any additional adjustments are required for the condenser fan power setting (step 312). Preferably, step 312 comprises a determination as to whether any additional relative energy determinations are required for any additional fan power settings at the current ambient temperature and air conditioning load for the vehicle in the wind tunnel This determination is preferably made by the control unit 106 of FIG. 1, most preferably by the processor 116 thereof

If it is determined in step 312 that additional adjustments are required for the condenser fan power setting, then the fan power setting is adjusted accordingly (step 314). The fan power setting adjustments are preferably made by the control unit 106 of FIG. 1, most preferably by the processor 116 thereof The process then returns to step 308. Steps 308-314 repeat in various iterations until there is a determination in step 312 that additional adjustments are not required for the fan power setting.

In a preferred embodiment, the condenser fan power setting is adjusted upward in ten percent (10%) increments of the maximum power setting for the fan for each iteration of step 314 until the fan power setting is set equal to one hundred percent (100%) of the maximum power setting for the fan. Specifically, in a first iteration of step 314, the fan power setting is preferably increased from ten percent (10%) of the maximum power setting for the fan to twenty percent (20%) of the maximum power setting for the fan. In a second iteration of step 314, the fan power setting is preferably increased from twenty percent (20%) of the maximum power setting for the fan to thirty percent (30%) of the maximum power setting for the fan, and so on, until the fan power setting is set equal to one hundred percent (100%) of the maximum power setting for the fan. When the fan power setting has reached one hundred percent (100%) of the maximum power setting for the fan, the control unit 106 of FIG. 1 preferably determines in the next iteration of step 312 that additional fan power setting adjustments are unnecessary.

Once it is determined in an iteration of step 312 that no additional fan power adjustments are necessary, a determination is made as to the lowest energy solution (step 316). The lowest energy solution comprises a condenser fan power level setting that minimizes energy usage of the air conditioning system (and that maximizes energy efficiency for the vehicle) at the current ambient temperature and air conditioning load for the vehicle in the wind tunnel Specifically, the lowest energy solution includes an optimal (or preferred) fan power setting for the current ambient temperature and air conditioning load for the vehicle in the wind tunnel, as determined using the measurements of step 310 for the various fan power settings for these conditions. The lowest energy solution preferably comprises a fan power setting for these conditions that minimizes the total combined energy usage of the condenser fan 102 of FIG. 1 and the compressor 104 of FIG. 1. The lowest energy solution is preferably determined by the control unit 106 of FIG. 1, most preferably by the processor 116 thereof.

The lowest energy solution is then recorded and/or stored (step 318). Specifically, (i) the current ambient temperature, (ii) the current air conditioning load, and (iii) the optimal (or preferred) fan power setting corresponding to the current ambient temperature and the current air conditioning load are preferably stored together as a single, paired, three variable value as part of a calibration relating ambient temperature, requested air conditioning load, and condenser fan power level. The value is preferably stored as part of the calibration in the form of a look-up table 132 in the memory 118 of FIG. 1 by the processor 116 of FIG. 1 for future use in controlling the air conditioning system of the vehicle, as set forth in further steps of the process 200 set fort in FIG. 2 and described further below in connection therewith.

A determination is made as to whether any additional adjustments are required for the ambient temperature (step 320). Preferably, step 320 comprises a determination as to whether any additional relative energy determinations are required for any additional ambient temperature levels for the current air conditioning load. This determination is preferably made by the control unit 106 of FIG. 1, most preferably by the processor 116 thereof.

If it is determined in step 320 that additional adjustments are required for the ambient temperature, then the ambient temperature is adjusted accordingly (step 322). Preferably, during step 322, the ambient temperature surrounding the vehicle inside the wind tunnel is adjusted. The ambient temperature adjustments are preferably made by the control unit 106 of FIG. 1, most preferably by the processor 116 thereof The process then returns to step 308. Steps 308-322 repeat in various iterations until there is a determination in step 320 that additional adjustments are not required for the ambient temperature. For each of the adjusted ambient temperatures, an optimal (or preferred) fan power level is determined for each specific ambient temperature given the current air conditioning load in a respective iteration of step 316, and an additional three-variable data point of the respective optimal (or preferred) fan power level and the current ambient temperature and air conditioning load are stored in the calibration in a respective iteration of step 318.

In a preferred embodiment, the ambient temperature is adjusted downward in ten degree Fahrenheit increments for each iteration of step 322 until the ambient temperature is set equal to sixty degrees Fahrenheit (60° F.). Specifically, in a first iteration of step 322, the ambient temperature is preferably decreased from one hundred twenty degrees Fahrenheit (120° F.) to one hundred ten degrees Fahrenheit (110° F.). In a second iteration of step 322, the ambient temperature is preferably decreased from one hundred ten degrees Fahrenheit (110° F.) to one hundred degrees Fahrenheit (100° F.), and so on, until the ambient temperature reaches Fahrenheit (60° F.). After the ambient temperature reaches Fahrenheit (60° F.), the control unit 106 of FIG. 1 preferably determines in the next iteration of step 320 that additional ambient temperature adjustments are unnecessary.

Once it is determined in an iteration of step 320 that no additional ambient temperature adjustments are necessary, a determination is made as to whether any additional adjustments are required for the air conditioning load (step 324). Preferably, step 324 comprises a determination as to whether any additional relative energy determinations are required for any additional air conditioning load levels. This determination is preferably made by the control unit 106 of FIG. 1, most preferably by the processor 116 thereof.

If it is determined in step 324 that additional adjustments are required for the air conditioning load, then the air conditioning load is adjusted accordingly (step 326). The air conditioning load adjustments are preferably made by the control unit 106 of FIG. 1, most preferably by the processor 116 thereof The process then returns to step 308. Steps 308-326 repeat in various iterations until there is a determination in step 324 that additional adjustments are not required for the air conditioning load. For each of the adjusted air conditioning loads, an optimal (or preferred) condenser fan power level is determined for each specific air conditioning load given the current ambient temperature in a respective iteration of step 316, and an additional three-variable data point of the respective optimal (or preferred) fan power level and the current air conditioning load and air conditioning load are stored in the calibration in a respective iteration of step 318.

In one embodiment, the air conditioning load is adjusted downward in accordance with a predetermined increment during each iteration until the control unit 106 of FIG. 1 preferably determines in the next iteration of step 324 that additional air conditioning load adjustments are unnecessary. However, this may not be necessary in certain embodiments. For example, in certain embodiments, the air conditioning load need not be varied for the calibration of the condenser fan 102. In general, air conditioning load is a function of driving condition (in this case we have limited the driving condition to idle, in which vehicle is stopped) and ambient air temperature. Humidity and solar load may also play a part. Evaporator blower speed, which may be set by the driver or may be determined by the programming for an automatic air conditioning system, is also a factor in determining air conditioning load. Air conditioning refrigerant pressure is a direct indicator or response to air conditioning load and is part of the control algorithm. Air conditioning refrigerant or “head” pressure may be used to control condenser fan speed (such as Off/Low/High). However, the methods and systems described herein preferably relate an ambient temperature and an air conditioning refrigerant pressure to a condenser fan power output, such as “air conditioning head pressure=1650 kPa, ambient air temperature=30 C, Fan Power=22%”. This relationship or calibration would be an outcome of the testing which determines that, for the aforementioned vehicle operating condition, 22% fan power resulted in the least vehicle energy consumption (best fuel consumption), balancing compressor torque versus fan power. Accordingly, while the specific lookup table in the engine control module (ECM) (an/or the methods and systems described herein) may relate fan power command to air conditioning load (refrigerant or head pressure) and ambient air temperature, the air conditioning load at idle is accurately indicated by air conditioning head pressure and, in itself, does not need to be used as an independent variable in defining a best calibration in certain embodiments.

Once it is determined in step 324 that no additional air conditioning load adjustments are necessary, the calibration is finalized (step 328). Specifically, each of the three-variable data points of the respective iterations of steps 316 and 318 are stored together in the calibration. Each of the three-variable data points provides an optimal (or preferred) fan power level (as a dependent variable) for a particular combination of the ambient temperature and the requested air conditioning load (ad the dependent variables). The calibration may thus be used to optimize the fan power setting in response to a specific ambient temperature and requested air conditioning load during operation of the vehicle, as set forth further below with reference to FIG. 2. The finalized calibration preferably comprises a look-up table 132 of FIG. 1 that is stored in the memory 118 of FIG. 1. The sub-process 201 is thus completed.

Returning now to FIG. 2, the process 200 proceeds to steps 202-210, described below. Steps 202-210 are performed after the engine of the vehicle is turned on by an operator in a driving environment, such as on a road or a driveway, rather than a wind tunnel or another testing environment. Steps 202-210 are preferably each performed while the engine of the vehicle is operating in an idle condition in such a driving environment.

Under these conditions, an ambient temperature is obtained (step 202). In one embodiment, ambient temperature preferably pertains to a current ambient temperature outside of and immediately surrounding the vehicle in the driving environment. In one embodiment, the ambient temperature is measured by an ambient temperature sensor 108 of FIG. 1, preferably from a sensor outside the vehicle, such as behind the grille of the vehicle. In another embodiment, the ambient temperature is obtained via a receiver 112 of FIG. 1, for example from a weather service. In yet another embodiment, the ambient temperature is obtained by another vehicle module 114 of FIG. 1, such as engine control system and/or another vehicle system that utilizes ambient temperature values. In either case, the ambient temperature is preferably provided to the processor 116 of FIG. 1 for processing and for use in controlling the air conditioning system of the vehicle.

A requested air conditioning load for the air conditioning system is also obtained (step 204). The requested air conditioning load preferably pertains to a preferred air conditioning temperature setting desired by a user of the vehicle. In one embodiment, the air conditioning load is measured by an input sensor 108 of FIG. 1. In another embodiment, the requested air conditioning load is obtained via a receiver 112 of FIG. 1, for example from a wireless communication with the user, for example sent via a key fob operated by the user as part of a vehicle remote start device. In yet another embodiment, the ambient temperature is obtained by another vehicle module 114 of FIG. 1, such as a dashboard input module that receives inputs from the user. In either case, the air requested air conditioning load is preferably provided to the processor 116 of FIG. 1 for processing and for use in controlling the air conditioning system of the vehicle.

A calibration is then retrieved (step 206). The calibration preferably corresponds to the calibration generated using the steps of the sub-process 201 of FIG. 3. The calibration preferably comprises a look-up table 132 of FIG. 1 relating an optimal (or preferred) condenser fan power level of the condenser fan 102 of FIG. 1 with the ambient temperature and the requested air conditioning load. Specifically, as mentioned above, the calibration preferably comprises a look-up table that provides an optimal (or preferred) fan power level setting (as the dependent variable) for various particular combinations of ambient temperature and requested air conditioning load (as the independent variables). The calibration is preferably retrieved by the processor 116 of FIG. 1 from the memory 118 of FIG. 1.

The optimal (or preferred) condenser fan power level is then determined for the current conditions (step 208). The optimal (or preferred) fan power level corresponds to a power level of the fan that minimizes the energy used by the air conditioning system under the current conditions. Specifically, in a preferred embodiment, the optimal (or preferred) fan power level is determined for the condenser fan 102 of FIG. 1 by the processor 116 of FIG. 1 given the current ambient temperature and requested air conditioning load, using the calibration retrieved in step 208.

The fan is then set to the optimal (or preferred) fan power level (step 210). Preferably, the condenser fan 102 of FIG. 1 is set to the fan power level setting that minimizes energy usage by the air conditioning system, as determined in step 208. The condenser fan 102 of FIG. 1 is preferably set to the optimal (or preferred) fan power level by instructions provided to the condenser fan 102 by the processor 116 of FIG. 1.

Accordingly, improved methods and systems are provided for controlling air conditioning systems of vehicles. The improved methods and systems control a power setting for a condenser fan of the air conditioning system using a pre-stored calibration that optimizes energy usage by the air conditioning system given the current ambient temperature surrounding the vehicle and the current requested air conditioning load, for example as expressed by a user of the vehicle. The improved methods and systems thus can help to improve energy efficiency of the air conditioning system, and thereby improve fuel economy for the vehicle.

It will be appreciated that the disclosed methods and systems may vary from those depicted in the Figures and described herein. For example, as mentioned above, the controller 110 of FIG. 1 may be disposed in whole or in part in any one or more of a number of different vehicle units, devices, and/or systems. In addition, it will be appreciated that certain steps of the process 200 and/or the sub-process 201 thereof may vary from those depicted in FIGS. 2 and 3 and/or described above in connection therewith. It will similarly be appreciated that certain steps of the process 200 and/or the sub-process 201 thereof may occur simultaneously or in a different order than that depicted in FIGS. 2 and 3 and/or described above in connection therewith. It will similarly be appreciated that the disclosed methods and systems may be implemented and/or utilized in connection with any number of different types of automobiles, sedans, sport utility vehicles, trucks, and/or any of a number of other different types of vehicles, and in controlling any one or more of a number of different types of air conditioning systems in vehicles.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof

We claim:

1. A method for controlling an air conditioning system of a vehicle, the air conditioning system having a condenser fan, and the method comprising the steps of:
obtaining an ambient temperature; and
controlling a setting for the condenser fan that controls energy usage of the air conditioning system based at least in part on the ambient temperature.

2. The method of claim 1, further comprising the step of:
obtaining a desired load for the air conditioning system, wherein the step of controlling the setting for the condenser fan comprises the step of controlling the setting for the condenser fan that controls the energy usage of the air conditioning system based at least in part on the ambient temperature and the desired load.

3. The method of claim 1, wherein the vehicle includes an engine, and the engine is operating at an idle condition as the setting for the condenser fan is controlled.

4. The method of claim 1, wherein:
the air conditioning system further comprises a compressor; and
the step of controlling the setting for the condenser fan comprises the step of controlling the setting for the condenser fan that minimizes a total combined energy usage for the condenser fan and the compressor.

5. The method of claim 1, wherein the step of controlling the setting for the condenser fan comprises the step of controlling the setting for the condenser fan using a calibration relating the setting of the condenser fan to the ambient temperature.

6. The method of claim 5, further comprising the steps of:
operating the condenser fan at a plurality of power levels for each of a plurality of temperature values of the ambient temperature;
determining an amount of energy used by the air conditioning system at each of the plurality of power levels for each of the plurality of temperature values, generating energy determinations; and
generating the calibration using the energy determinations.

7. The method of claim 5, further comprising the steps of:
operating the condenser fan at a plurality of power levels for each of a plurality of temperature values of the ambient temperature at each of a plurality of desired loads for the air conditioning system;
determining an amount of energy used by the air conditioning system at each of the plurality of power levels for each of the plurality of temperature values for each of the plurality of desired loads for the air conditioning system, generating energy determinations; and
generating the calibration using the energy determinations.

8. A method for generating a calibration for use in controlling an air conditioning system of a vehicle, the air conditioning system having a condenser fan, and the method comprising the steps of:
setting an ambient temperature to an ambient temperature value;
operating the condenser fan at a plurality of power levels at the ambient temperature value;
determining an amount of energy used by the air conditioning system at each of the plurality of power levels, generating energy determinations; and
determining, using a processor and the energy determinations, a selected power level of the plurality of power levels for the ambient temperature value, for the calibration.

9. The method of claim 8, further comprising the steps of:
setting the ambient temperature to one or more additional ambient temperature values;
operating the condenser fan at the plurality of power levels at each of the one or more additional ambient temperature values;
determining the amount of energy used by the air conditioning system at each of the plurality of power levels for each of the one or more additional ambient temperature values, generating one or more additional energy determinations; and
determining, using the processor and the one or more additional energy determinations, one or more additional selected power levels of the plurality of power levels for each of the one or more additional ambient temperature values, for the calibration.

10. The method of claim 8, wherein:
the step of operating the condenser fan comprises the step of operating the condenser fan at the plurality of power levels for each of a plurality of air conditioning loads at the ambient temperature value;
the step of determining the amount of energy comprises the step of determining the amount of energy used by the air conditioning system at each of the plurality of power levels for each of the plurality of air conditioning loads, generating the energy determinations; and
the step of determining the selected power level comprises the step of determining, using the processor and the energy determinations, a preferred power level of the plurality of power levels for each of the plurality of air conditioning loads for the ambient temperature, for the calibration.

11. The method of claim 10, further comprising the steps of:
setting the ambient temperature to one or more additional ambient temperature values;
operating the condenser fan at the plurality of power levels for each of the plurality of air conditioning loads at each of the one or more additional ambient temperature values;
determining the amount of energy used by the air conditioning system for each of the plurality of power levels for each of the plurality of air conditioning loads at each of the one or more additional ambient temperature values, generating one or more additional energy determination; and
determining, using the processor and the one or more additional energy determinations, one or more additional selected power levels of the plurality of power levels for the condenser fan for each of the one or more additional ambient temperature values for each of the plurality of air conditioning loads, for use in the calibration.

12. The method of claim 8, wherein the vehicle includes an engine, and the engine is operating in an idle condition as the condenser fan is run.

13. A system for controlling an air conditioning system of a vehicle, the air conditioning system having a condenser fan, and the system comprising:
a sensor configured to measure an ambient temperature; and
a controller coupled to the sensor and configured to control a setting for the condenser fan that controls energy usage of the air conditioning system based at least in part on the ambient temperature.

14. The system of claim 13, wherein the controller is further configured to:
obtain a desired load for the air conditioning system; and
control the setting for the condenser fan that controls the energy usage of the air conditioning system based at least in part on the ambient temperature and the desired load.

15. The system of claim 13, wherein the vehicle includes an engine, and the engine is operating at an idle condition as the setting for the condenser fan is controlled.

16. The system of claim 13, wherein:
the air conditioning system further comprises a compressor; and
the controller is further configured to control the setting for the condenser fan that minimizes a total combined energy usage for the condenser fan and the compressor.

17. The system of claim 13, wherein the controller is further configured to:
control the setting for the condenser fan using a calibration relating the setting of the condenser fan to the ambient temperature.

18. The system of claim 17, wherein the controller comprises:
a memory configured to store the calibration; and
a processor coupled to the memory and configured to:
retrieve the calibration from the memory; and
control the setting for the condenser fan using the calibration.

19. The system of claim 17, wherein:
the controller is further configured to run the condenser fan at a plurality of power levels for each of a plurality of temperature values of the ambient temperature;
the system further comprises a second sensor configured to measure an amount of fuel used by the vehicle at each of the plurality of power levels for each of the plurality of temperature values, generating fuel measurements; and
the controller is further configured to generate the calibration using the fuel measurements.

20. The system of claim 17, wherein:
the controller is further configured to run the condenser fan at a plurality of power levels for each of a plurality of temperature values of the ambient temperature at each of a plurality of desired loads for the air conditioning system;
the system further comprises a second sensor configured to measure an amount of fuel used by the vehicle at each of the plurality of power levels for each of the plurality of temperature values for each of the plurality of desired loads for the air conditioning system, generating fuel measurements; and
the controller is further configured to generate the calibration using the fuel measurements.
